(19) United States
(12) Patent Application Publication
(10) Pub. No.: US 2005/0269436 A1
(43) Pub. Date: Dec. 8, 2005

(54) Cone rock crusher

(75) Inventors: Ulhas S. Sawant, Hartland, WI (US); James A. Sheridan, Greendale, WI (US)

Correspondence Address: RYAN KROMHOLZ & MANION, S.C., POST OFFICE BOX 26618, MILWAUKEE, WI, 53226, US

(73) Assignee: Innotech Solutions, LLC

(21) Appl. No.: 11/141,658

(22) Filed: May 31, 2005

Related U.S. Application Data
(63) Continuation-in-part of application No. 10/861,953, filed on Jun. 4, 2004.

(51) Int. Cl. B02C 2/02

(52) U.S. Cl. 241/215

(57) ABSTRACT

An improved cone-style rock crusher. The rock crusher may be adjusted for varying rock crushing specifications, including different speeds, throws, and liners. The rock crusher comprises a frame that supports a crushing bowl, a crusher head and a shaft, with the shaft being secured to the crusher head. A domed feed plate may be secured onto the crusher head for assistance in secondary rock crushing processes. An eccentric bushing allows the shaft to be aligned properly, regardless of whether there is a load or not within the crushing bowl. The bushing is tapered downwardly, which allows for evenly dispersed contact along the length of the shaft as it gyrates. Furthermore, the thickness of the bushing is asymmetrical. The rock crusher further comprises uniquely designed tramp release cylinders that provide a safeguard that acts as shock absorbers when the rock crusher encounters tramp material.

### RELATED APPLICATIONS

This application is a continuation-in-part of patent application Ser. No. 10/861,953, filed on 4 Jun. 2004.

### BACKGROUND OF THE INVENTION

The present invention relates to rock crushers and improved cone-style rock crushers that provide optimal performance for each rock crushing application.

Numerous rock crushers have been designed to crush and fragment rocks into smaller pieces. Cone-style crushers are a common type of rock crushers. Rocks are fed into the crusher through a rotating feed distributor or on top of the feed plate, which distributes the rocks into a crushing cavity. A crusher head mounted on a shaft is located within the crushing bowl. The shaft rotates or gyrates and crushes the entering rocks. The rocks exit below the crusher and are carried away for further sorting, or to be recycled and reprocessed in the rock crusher.

However, due to the demanding environment that rock crushers are employed within, repair and maintenance of the rock crushers is common. Much downtime is spent repairing and replacing the components of the rock crusher, including, for example, bearings, bushings, and gearing. Prior art lubrication systems, protection systems and other internal arrangements have not been designed necessarily to optimize the life of the individual parts of the crusher. Repairs not only increase the time required to produce a desired amount of saleable rock products, but also increase the cost of saleable rock products.

Prior art rock crushers are generally designed for delivering rock products only within a specific size range. If the desired size of the final product is different than the current specifications, the rock crusher generally is not easily modifiable to produce the new product specifications. In prior art rock crushers, it is usually required to change the crushing head and/or the crushing bowl if one needs to change from a coarse secondary crushing arrangement to a fine tertiary crushing arrangement. Similarly, prior crushing bowl designs also did not allow easy changing between different crushing arrangements; variables, such as the throw, speed, and specific liners for specific rock products are not easily changeable in a single rock crusher for multiple rock specifications.

Thus, an improved rock crusher is needed that will address the above problems and further make operation easier and more efficient for the user. A preferable rock crusher will be able to handle varying product specifications in an efficient manner without requiring extensive retooling or reconfiguring of the rock crusher. Likewise, a rock crusher is needed that will minimize repairs and downtime thereby increasing efficiency and reducing costs for the user.

### SUMMARY OF THE INVENTION

The present invention is an improved cone-style rock crusher that will improve the quality and increase the quantity of the end products, while providing an overall more efficient and economical machine to operate. The rock crusher may be adjusted for varying rock crushing specifications, including different speeds, throws, and liners.

The rock crusher comprises a frame that supports a crusher bowl, a crusher head and a shaft, with the shaft being secured to the crusher head. The crusher head and the shaft are spaced apart and located within the crusher bowl. A domed feed plate may be secured onto the crusher head for assistance in secondary rock crushing processes. The shaft is driven by an electric drive system, which allows the shaft and crusher head to gyrate. An eccentric bushing allows the shaft to be aligned properly, regardless of whether there is a load or not within the crusher bowl.

The rock crusher further comprises uniquely designed tramp release cylinders that provide a safeguard by acting as shock absorbers when the rock crusher encounters tramp material. The cylinders are part of the release system that allows the crusher to adjust and prevent damage to the crusher components when uncrushable or tramp material enters the crusher bowl.

Within the rock crusher sits the crusher head and shaft assembly. The assembly rotates or gyrates, which allows a mantle located on the exterior of the crusher head to come in close proximity of the rock crusher bowl for crushing rocks. As the shaft gyrates, especially without rocks in the crushing chamber, the shaft comes in contact with the bushing, which acts as an abutting surface for the maximum outer movement of the shaft. The bushing is tapered downwardly, which allows for evenly dispersed contact along the length of the shaft as it gyrates. Furthermore, the thickness of the bushing is asymmetrical, with the thickness evenly varying from a predetermined maximum thickness to a predetermined minimum thickness. The asymmetrical thickness further provides for an even abutting surface for the shaft to contact. The result is a shaft load that is dispersed over a wide area of the bushing, which virtually eliminates burning of the bushing. In addition, the reduced clearance between the shaft and the bushing creates better hydrodynamic bearing action, resulting in enhanced load capabilities for the bushing. Overall, the combination of the factors improves the reliability of the crusher and the crushing process. In addition the bushing is designed so as to change the crusher throw by changing its geometry.

The interaction of all of the features of the rock crusher allows the rock crusher to be adjusted to different combinations of speeds, throws and liner combinations, thereby producing more saleable products compared to previous rock crushers. The crusher allows adjustment of the throw and speed of the crusher to be synchronized properly with the horsepower of the crusher's motor, thereby optimizing the crushing ability of the crusher.

### BRIEF DESCRIPTION OF THE DRAWINGS

FIG. 1 shows a perspective view of a rock crusher in accordance with the present invention.

FIG. 2 is a cut-away perspective sectional view of the rock crusher of FIG. 1 taken along the line 2-2 of FIG. 1.

FIG. 3 is a cross-sectional view of the rock crusher in FIG. 1 taken along line 3-3 of FIG. 1.

FIG. 4 is a close-up cross-sectional view of the drive shaft of FIG. 3.

FIG. 5 is a cut-away perspective cross-sectional view of the drive shaft assembly of FIG. 3.

FIG. 6A depicts a sectional view of a shaft and bushing in accordance with the present invention.

FIG. 6B depicts an overhead view of the shaft and bushing of FIG. 6A.

FIG. 7 is a cut-away perspective view of a head assembly in accordance with the present invention.

FIG. 8 is a close-up cross-sectional view of the head and shaft assembly of FIG. 3.

FIG. 9 is a side view of a tramp release system used in accordance with the present invention.

FIG. 10 is a cross-sectional view of an adjustment ring assembly according to the present invention used in conjunction with the tramp release system of FIG. 9.

### DESCRIPTION OF THE PREFERRED EMBODIMENT

Although the disclosure hereof is detailed and exact to enable those skilled in the art to practice the invention, the physical embodiments herein disclosed merely exemplify the invention which may be embodied in other specific structures. While the preferred embodiment has been described, the details may be changed without departing from the invention, which is defined by the claims.

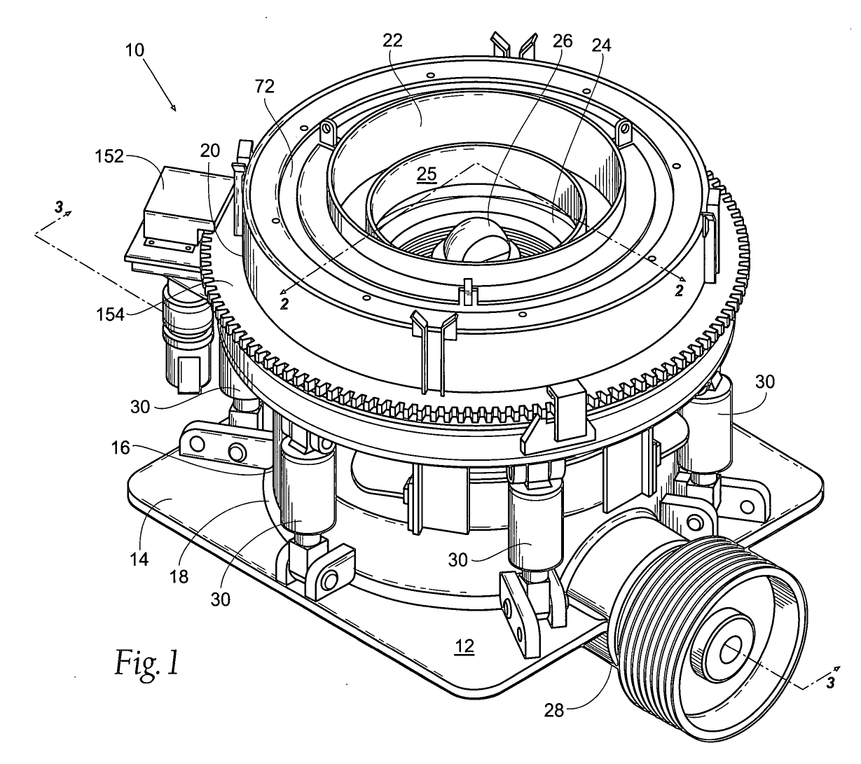

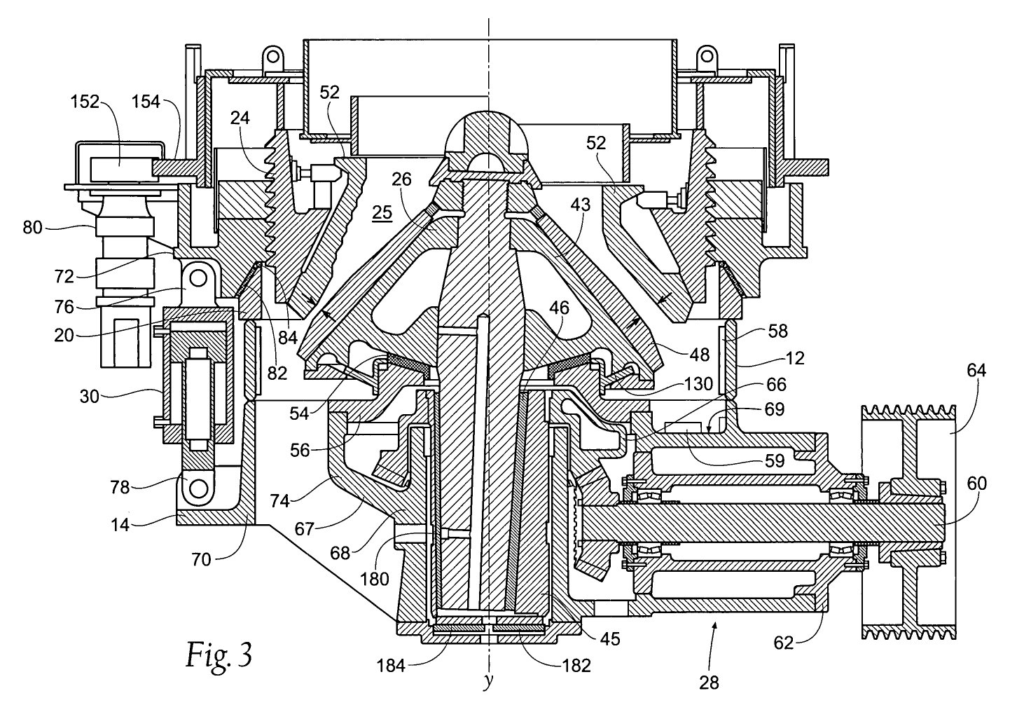

FIG. 1 shows a perspective view of a rock crusher 10 according to the present invention. The rock crusher 10 comprises a mainframe 12, comprising a base 14 and a body 16. The body 16 has a first end 18 connected to the base 14 and a second end 20 that supports an adjustment ring 72. A crusher bowl 24 is assembled into the adjustment ring 72 and is vertically adjustable through its rotation in relationship to the adjustment ring 72. The crusher bowl 24, along with a head and shaft assembly 26 that further comprises a crusher head 43 (see FIG. 3), forms a crushing cavity 25 for rock crushing to take place. The head and shaft assembly 26 gyrates to crush rocks as they enter the crusher bowl 24. A drive assembly 28 provides power means for the head and shaft assembly 26. A plurality of clamping cylinders 30 secures the adjustment ring 72 to the top end 20 of the frame 12 while crushing occurs, and also provides shock absorption for the rock crusher 10. The overall arrangement of the rock crusher 10 provides an improved system that maximizes saleable products and minimizes waste by allowing a range of combinations of throw, speed, and liners to maximize the power draw and thus optimize the specific needs of a user.

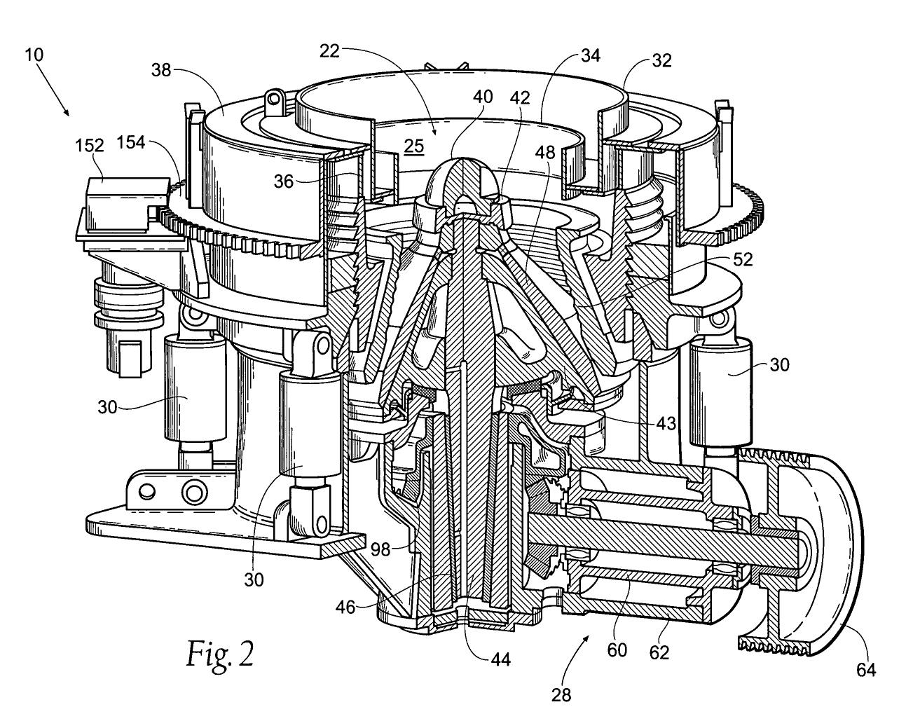

FIG. 2 provides a partial sectional view of the rock crusher 10 along the line 2-2 of FIG. 1. The opening 22 is generally defined by a feed cone 32, which is held in place by a feed cone adapter 34 and an upper bowl ring 36. The feed cone 32 is further positioned with the use of an adjustment cap 38.

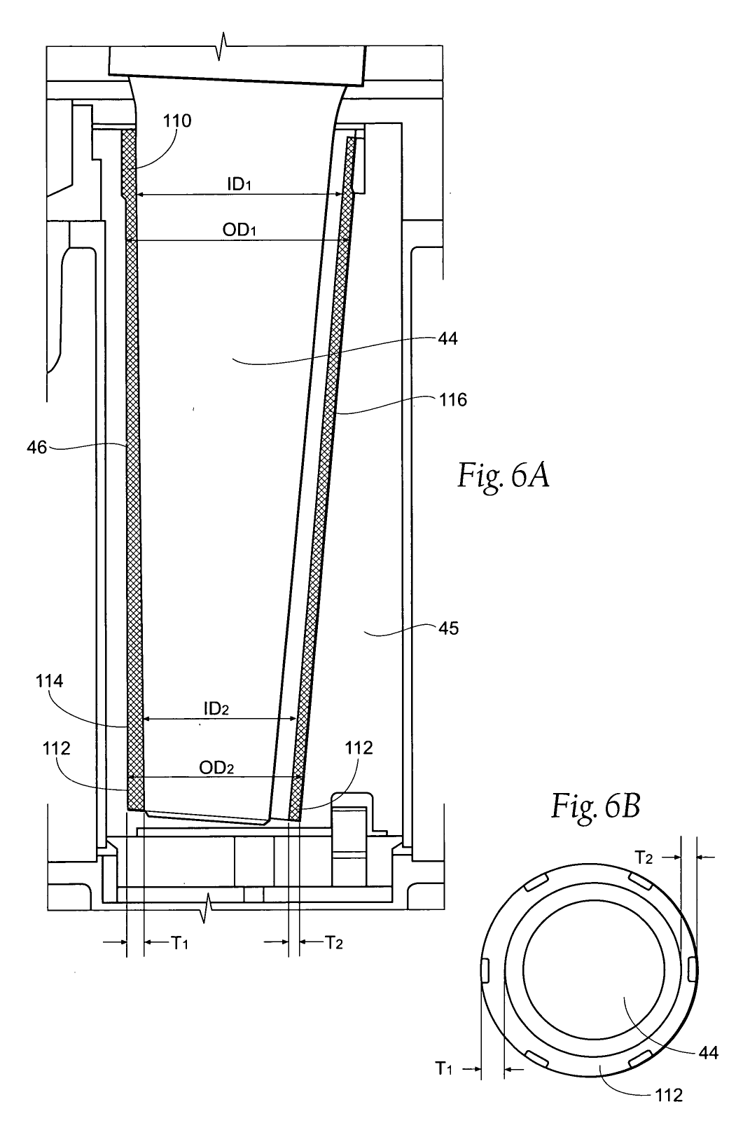

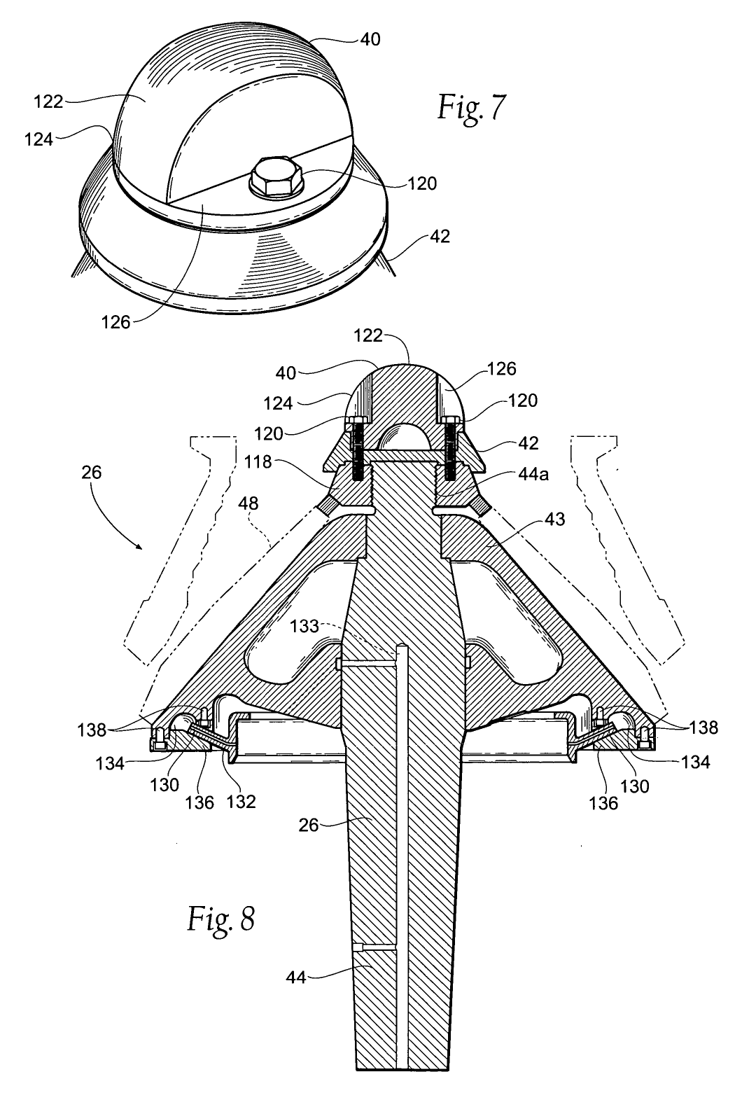

Once rocks enter the opening 22 into the cavity 25 within the bowl 24, they will encounter a dome feed plate 40 that is supported by a feed plate 42. The dome feed plate 40 helps to evenly distribute rocks within the bowl 24 and prevents rocks from getting trapped or stuck within the bowl 24. The feed plate 40 is supported by the head and shaft assembly 26. The assembly 26 generally comprises the head 43 and the shaft 44, with the shaft 44 rotating and gyrating within the bushing 46. The feed plate 40 will be discussed further with respect to FIGS. 7 and 8, and the shaft 44 and the bushing 46 will be discussed further with respect to FIGS. 6A and 6B.

The head 43 supports a mantle 48. The crusher bowl 24 supports a liner 52. The slope of the head 43 is steeper than some designs, which provides for a higher volumetric capacity than in the prior art. A useful angle of the head may be 50 degrees from horizontal. As the head 43 rotates or gyrates, the mantle 48 works together with a bowl liner 52 to provide the necessary surfaces and interaction for rock crushing between the bowl 24 and the head 43 within the cavity 25. The design of the head 43 and the mantle 48 are of a unique universal design. This design allows use of a single mantle and head for crushing rocks, ranging from a coarse secondary crushing to a fine tertiary crushing, whereas previous rock crushers required changing the head for these different crushing arrangements. Thus, the present invention further saves money and operating time over prior art crushers by minimizing the number of changed parts required for different crushing parameters.

FIG. 3 provides a cross-sectional view of the rock crusher 10 taken along the line 3-3 of FIG. 1. The rock crusher 10 is designed so that the bowl liner 52 may be of differing specifications, depending on the needs of the user. However, a preferable bowl liner 52 is designed to maintain a nip angle at 21 degrees or less between the mantle and the bowl liner, which will minimize slippage of the rocks and, thus, wear on the liner 52 and the mantle 48. Along with the bowl liner 52 and the mantle 48, the crusher 10 is designed with other liners and devices to provide protection for the crusher 10. For instance, a socket liner 54 sits upon a socket 56, with the socket liner 54 providing a seal and bearing for the head 43 when gyrating within the cavity 25. A frame liner or frame liners 58 are positioned within the frame 12 to protect the frame 12 when rocks are passing through the cavity 25. An arm guard or arm guards 59 also protect the frame 12 and its components. The arm guards 59 are autogenously designed so that the falling rocks form a dead bed, which further minimizes wear on the supporting arms 69 and, also, minimizes wear to the guards 59, themselves. The liners 58 are preferably designed of wear resistant steel, thereby minimizing the wear caused by the tumbling rocks.

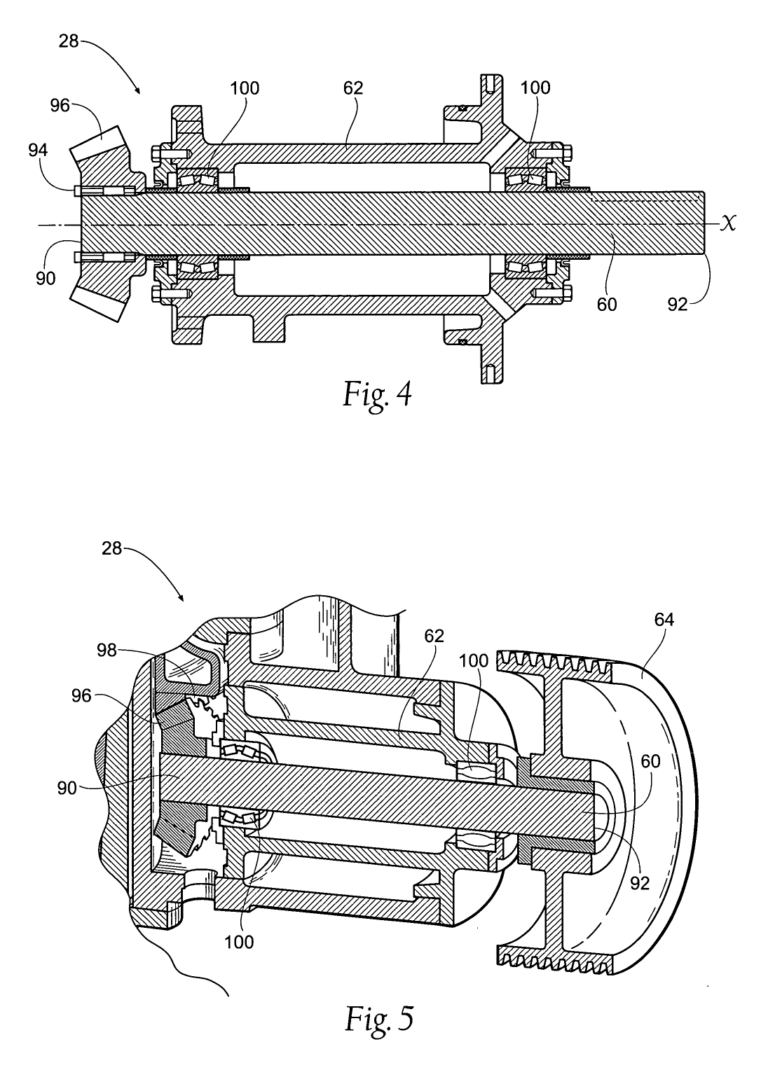

Referring to FIGS. 2 and 3, the drive assembly 28 comprises a countershaft 60 that provides the means for gyrating the head and shaft assembly 26. The countershaft sits within a countershaft box 62 and a sheave 64, which protects the countershaft from dust and dirt. The drive assembly will be discussed further with respect to FIGS. 4 and 5.

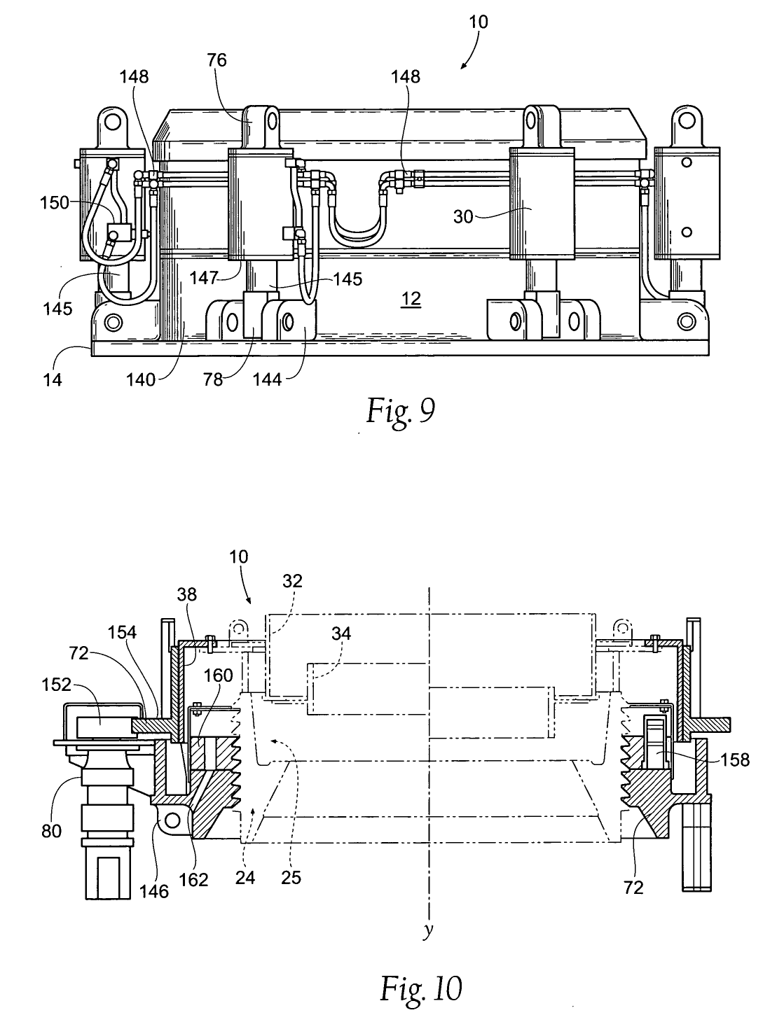

Referring again to FIG. 3, the body 16 of the frame 12 is generally comprised of a top end that supports the adjustment ring 72 and a bottom half 74. The clamping cylinders 30 have an upper end 76 connected to the adjustment ring 72 and a lower end 78 connected to base 14 of the frame 12. The cylinders 30 are connected to a hydraulic power unit (not shown) that provides the necessary means so that the cylinders 30 can act as shock absorbers for the rock crusher 10. A seat liner 82 and a fulcrum bar 84 are located between the adjustment ring 72 and the top end 20 of the body 16, which assures that the adjustment ring 72 sits properly on top of the frame 12 and reduces wear on the frame 12, overall. The seat liner 82, the fulcrum bar 84, the cylinders 30 and the hydraulic motor 80 will be discussed in further detail with respect to FIGS. 9 and 10.

The unitary, one-piece molded design of the bottom half 74 of the frame 12 allows adjustment between coarse secondary crushing to a fine tertiary crushing with only needing to change the bowl liner 52. The bottom half 74 comprises a mounting flange 67, a central hub 68, supporting arms 69, and an outer shell 70, all of which are cast as a one-piece design. This unitary design gives the crusher 10 extra rigidity and strength to sustain wear and tear associated with overloads that was not previously found in the prior art.

Referring further to FIG. 3, the head and shaft assembly 26 is shown in gyratory fashion, rotating around a central axis Y. As the shaft 44 gyrates around the axis Y, it will come into contact with the bushing 46, which has an eccentric design. This arrangement allows the throw of the cone crusher, which is the difference of the maximum distance between the bowl liner 52 and the mantle 48 (see, for example, the right side of FIG. 3) and the minimum distance between the bowl liner 52 and the mantle 48 (see, for example, the left side of FIG. 3), to be varied for the rock crusher 10 for the optimization of the production of the saleable rock. Furthermore, to effectively provide full balance for the head and shaft assembly 26 at a wide range of throws and speeds for the crusher 10, a counterweight 66 is provided that surrounds the eccentric 45 and bushing 46. The bushing 46 is retained within the eccentric 45 by a key. This is an improvement over the prior art, and the unique design allows quick and easy installation or removal of the bushing 46, which increases the overall efficiency of the rock crusher 10. Furthermore, because the crusher 10 can handle a wider range or crushing parameters, the settings may be changed during the crushing process, thereby providing an overall more efficient process.

FIGS. 4 and 5 depict the drive shaft assembly 28. The drive shaft or countershaft 60 sits within the countershaft box 62. The drive shaft 60 preferably does not have any shoulders, grooves, or other sectional changes along the shaft 60, which increases the strength of the shaft 60. The drive shaft 60 has a first end 90 and a second end 92 and rotates about an axis X. The first end 90 sits within a locking collar 94 that connects the drive shaft 60 to a pinion 96. The locking collar 94 is preferably tapered, thereby making the mounting of the pinion 96 on the shaft 60 easier, which makes the assembly and removal process of the drive shaft assembly 28 easier, as well. The pinion 96 in turn is engaged to a gear 98, preferably a spiral bevel gear, which translates the rotational movement of the drive shaft 60 into the gyrational movement for the head and shaft assembly 26. The second end 92 of the drive shaft 60 is connected to the sheave 64. The outside of the sheave 64 is arranged to receive a drive belt or drive belts (not shown) for connection to a motor or other power means (not shown). Tapered roller bearings 100 are used to support the rotation of the shaft 60. The bearings 100 are designed to effectively carry a load or force in all directions, which provides added flexibility to the assembly 28 in that the drive motor (not shown) may be mounted at different positions. As previously discussed, the arrangement of shaft 44, bushing 46, and the counterweight 66, allows the crusher to be run at a wide range of motor horsepower. The shaft 60 and the bearings 100 are preferably sealed within the countershaft box 62 and lubricated with a static oil bath, thereby minimizing the possibility of dirty oil being used in the assembly 28 and increasing the life of the individual parts of the assembly 28. Furthermore, the assembly 28 is designed for insertion or removal as a single cartridge, thereby facilitating potential replacement of the drive assembly 28 and allowing for less down time if replacement is necessary. Also, because the assembly 28 preferably is designed as a single cartridge, there is less opportunity for dirt to foul up the individual parts of the assembly 28 when inserting or removing the assembly 28, and, also, the design provides for a safer drive system than previous crusher designs.

FIG. 6A shows a side elevation view of the shaft 44 and the bushing 46 in accordance with the present invention. It is to be understood for the following discussion that the shaft 44 refers to the area of the shaft that comes in contact with the bushing 46, and not the entire shaft 44. The shaft 44 is depicted gyrating without a load of rocks in the crushing bowl 24 and cavity 25 (see FIG. 3). As disclosed in FIG. 6A, the bushing 46 has a top end 110 and a bottom end 112. The bushing 46 evenly tapers inwardly from the top end 110 to the bottom end 112, which results in the top end 110 having a first inner diameter ID₁ larger than that of a second inner diameter ID₂, located at the bottom end of the bushing 46. The arrangement of the bushing 46 allows the shaft 44 to evenly be in contact along the entire length of the bushing 46. This removes pinch point that was prevalent in the prior art, which resulted in the force and pressure exerted on the bushing being concentrated at a specific pinch point at the top end of the bushing. The prior are bottom end of the bushing did not make contact with the shaft, and the concentration of force at the pinch point lead to burning of the bushing, which leads to the failure of the bushing and other adverse effects on a rock crusher. In the present invention, the bushing 46 provides an abutment for the shaft 44 that is coextensive along the length of the shaft 44. Thus, contact between the shaft 44 and the bushing 46 is linearly displaced along the entire length of the shaft 44 as opposed to a single point, with the result being virtually no burning of the bushing 46 and a longer life for the bushing 46. A longer bushing life equates into less downtime for a rock crusher previously required to replace burnt bushings, which leads to an increase in productivity.

Still referring to FIG. 6A, the bushing 46 has a first outer diameter OD₁ located at the top end 110 of the bushing 46 and a second outer diameter OD₂ located at the bottom end 112 of the bushing, with the second outer diameter OD₂ being preferably less than that of the first outer diameter OD₁. The outer diameters are spaced apart from the inner diameters for illustrative purposes and to distinguish and clarify what dimension is referred to for each diameter; the respective inner and outer diameters should be considered as intersecting the bushing 46 at the same latitude. The outer diameters and the inner diameters are eccentric of one another, or are not centered on the same axes. More specifically, the first inner diameter ID₁ is eccentric of the first outer diameter OD₁, and the second inner diameter ID₂ is eccentric of the second outer diameter OD₂. However, the outer diameters OD₁ and OD₂ may be substantially coextensive along the same axes.

Referring further to FIG. 6A, the bushing 46 is shown having a first side 114 and a second side 116. The bushing 46 normally encircles the shaft 44, but is shown having the first side 114 and the second side 116 for illustrative purposes. Because of the eccentric diameters discussed above, the first side 114 has a first thickness T₁ and the second side 116 has a thickness T₂. The thickness T₁ can be thicker or thinner than the thickness T₂ depending on the amount of throw desired for the crusher. The overall thickness of the bushing 46 tapers evenly from the thickness T₁ to the thickness T₂. The tapered thickness of the bushing also contributes to the solid contact made between the shaft 44 and the bushing 46, thereby further reducing potential burning of the bushing 46.

FIG. 6B depicts an overhead view of the shaft 44 and the bushing 46. As described with respect to FIG. 6A, the overall thickness of the bushing 46 tapers evenly from the thickness T₁ to the thickness T₂. The thicknesses T₁ and T₂ do not necessarily need to be located on the right and left sides of the shaft 44, respectively. Since the bushing 46 is preferably circular throughout its length, it should be understood that actual orientation of the thickness T₁ and T₂ will be determined as to what angle or perspective a person is looking at the shaft 44 and the bushing 46.

The inward tapering of the bushing 46 and the tapering of the thickness do not have to be substantial to result in the desired effect for the crusher 10. For instance, in many industrial-sized rock crusher assemblies, the shaft 44 may be about 45 inches in length. This would be the length below the rock crusher head, and not include the length of the shaft that may extend inwardly of the crusher head. The first inner diameter ID₁ may be approximately about 13⅞ inches and the second inner diameter ID₂ may be approximately about 10¼ inches. The change in the bushing diameter is around 3 to 3½ inches, or approximately 1 inch taper in thickness for every 12 to 15 inches of the length of the shaft. Similarly, the difference between the thickness T₁ and T₂ of a bushing, for a shaft of about 45 inches in length, is approximately 130 mils, or approximately 1/8 of an inch. The slight adjustments are enough to provide for a more efficient bushing. It should also be understood that the above values could be adjusted depending on specific needs or arrangements for a rock crusher. Provided that the varying of the bushing dimensions produces an even, abutting surface along the entire length of the shaft, the values would fall within the scope of the invention.

The bushing 46 has been discussed as being evenly tapered. It may be possible that the outside of the bushing does not evenly taper, and the bushing would still fall within the scope of the invention. Also, either the top of the bushing or bottom of the bushing, where the bushing may not come in contact with the shaft, may not necessarily be evenly tapered either. Provided that the surface of the bushing that comes into contact with the surface of the shaft is evenly tapered so that individual pinch points between the shaft and the bushing are removed, the bushing would fall within the scope of the invention.

FIGS. 7 and 8 further depict the head and shaft assembly 26. The head 43 comprises the mantle 48. The mantle 48 is of a generally conical design, extending outwardly from the locking nut 118 to the edge of the head 43. The feed plate 42 is connected to the mantle with a locking nut 118. As previously noted, the domed feed plate 40 sits upon the feed plate 42 and is connected to the feed plate 42 with connecting means 120, such as bolts, screws, or other securing devices. Preferably, the domed feed plate 40 is removably secured to the dome feed plate 42. The domed feed plate 40 preferably has a curved, raised middle section 122 and two relatively flat side sections 124, 126. Though the shape of the side sections 124, 126 is not necessary for the present invention, they are arranged to facilitate installing or removing of the domed feed plate 40 when necessary, by providing easy access to the connection means 120.

The domed feed plate 40 has two primary advantages over the prior art. Rocks entering the crushing bowl 24 may be of any size or shape, including large, flat rocks, or “slabby” rocks. In prior art rock crushers, when these slabby rocks fell into the crushing bowl 24, they would have a tendency to get caught between the bowl liner 52 and the feed plate, which decreases productivity by slowing down the progression of the rocks through the crusher and potentially interrupting the crushing process by having to remove the slabby rocks. The present design of the domed feed plate 40 prevents such slabby rocks from getting caught or trapped in the crushing bowl 24. When the slabby rocks encounter the domed feed plate 40, the curved shape of the dome feed plate 40 provides a surface that will disorientate the rocks from a potentially horizontal, slab position and allow the rocks to proceed through the crushing cavity more efficiently.

The domed feed plate 40 also provides protection for the locking nut 118. The cost of replacing the locking nut 118 is much more than that of the domed feed plate 40 or the feed plate 42. Thus, the use of the domed feed plate 40 helps to reduce costs for the operation. Furthermore, the domed feed plate 40 has a more substantial size or height than the feed plate 42. As such, it can withstand more wear and tear from the entering rocks without wearing out, resulting in replacement of the feed plate 42 less frequently than in prior art designs. The domed feed plate 40 reduces down time for replacement parts, which increases the overall yield of the crusher 10 over prior art designs.

Referring further to FIGS. 3 and 8, the head and shaft assembly 26 further comprises a floating ring 130. The fluid is pumped through the passageway 132 through the wiper 130 into a cavity 134 surrounding the wiper 130. It should be understood that the system may have more than one wiper 130, passageway 132, or cavity 134, and still fall within the scope of the present invention. The use of singular references is for clarity and should not be considered as limiting on the invention. A seal retainer 136 is affixed to the head 43 to form the cavity 134. Fastening means 138, such as screws, bolts, or similar devices, secure the seal retainer 136 and the head 43 together. Preferably, the fastening means 138 are designed and arranged to insure they will not loosen when subject to vibrations and movements associated with the rock crusher 10. As the pumped fluid enters the cavity 134, it forms a protective barrier for the inner moving parts of the head 43. Dirt, dust, and debris will be prohibited from entering the cavity 134, thereby extending the lifetime of the head 43 and the shaft 44 and all of their various internal components. When the fluid is pumped into the cavity 134, it is possible that some of the fluid will pass outwardly into the rock discharge area and may coat some of the rocks with it. However, the amount of fluid that does discharge into the rock discharge area is a minimal amount and should not be considered as problematic, either with the crushing process or with environmental concerns.

A vertical groove 133 allows oil to be provided for the shaft assembly 26 and, also, the bushing 46. The groove 133 is preferably arranged at 90° to the load of the crusher 10, which further increases the load capacity of the bushing 46. The design of the groove 133 insures that the load capacity will be carried throughout the entire length of the bushing 46, which substantially increases the load capacity compared with prior art rock crushers. Also, as shown in FIG. 3, a side entry port 180 delivers lubrication to the shaft assembly 26. The side entry port 180 provides lubrication for a lower step bearing 182 and an upper step bearing 184, among other components of the shaft assembly 26, including the socket liner 54. This arrangement greatly reduces any potential pressure buildup below the eccentric 45, thereby minimizing problems associated with the eccentric 45 lifting upwards and resulting in nonalignment between the shaft 44 and the bushing 46, further increasing the efficiency of the rock crusher 10.

The head and shaft assembly 26 are designed to minimize stress caused by the interaction of the internal parts of the assembly 26. For instance, the shaft 44 and the head 43 are preferably connected through an interference fit, and further secured with the threaded portion 44a interacting with the locking nut 118. Together, these locking means prevent the head 43 loosening from the shaft 44 due to flexing or bending of the shaft 44 under a crushing load. Also, the pivot point for the gyration of the head 43 is relatively higher compared to previous designs, which allows the mantle 48 to travel in a direct line towards the bowl liner 52 (see FIG. 3). This allows rocks to be pinched and crushed directly without slippage. To further minimize stress and wear on the various liners of the crusher 10, the head and shaft assembly 26 rotates at a very slow rate, preferably 30 RPM or less, when there is no load in the cavity 25. Overall, the head and shaft assembly 26 is much more efficient than prior art assemblies.

FIGS. 9 and 10 further depict the crusher 10 and the frame 12. The frame 12 is designed so that the clamping cylinders or tramp cylinders 30 will act as shock absorbers for the crusher 10 when the crusher 10 encounters an un-crushable or tramp material. FIG. 9 depicts the clamping cylinders 30 arranged around the outside of a lower section 140 of the body 16 of the frame 12. FIG. 10 depicts the adjustment ring assembly 72, which sits on top of the frame 12. The lower end 78 of the cylinder 30 is connected to a mount 144 located on the base 14 of the frame 12. The upper end 76 of the cylinder 30 is connected to an upper mount 146 located on the adjustment ring 72. The cylinders 30, which are preferably a rod-type hydraulic cylinder, will allow the adjustment ring 72 to lift off the mainframe 12 when tramp material is encountered between the mantle 48 and the bowl liner 52 (see FIG. 3), thereby allowing the tramp material to pass through the crushing cavity and preventing the crusher from jamming. The mount 144 and the upper mount 146 preferably comprise a simple clevis and pin design, which allows the cylinders 30 to rotate slightly when tramp material is passed through the bowl 24, or when the tramp material is jammed within the bowl 24. Also, the cylinders 30 are preferably mounted upside-down with respect to conventional mounting styles, which further protects the internal cylinder rods 145 and the seals 147 from dirt that accumulates during the crushing process. The added mobility and arrangement of the cylinders 30 helps to minimize wear on the cylinders 30 and improve the reliability of the cylinders.

As shown in FIG. 9, the cylinders 30 are connected by a plurality of fluid lines 148 that allow fluid to flow through the cylinders 30. The fluid lines 148 also connect each of the cylinders 30 to a built in relief valve 150. The relief valves 150 maintain a predetermined pressure for the cylinders 30 and are preferably of a cartridge-type valve that may easily be replaced if necessary. When material jams up the crusher 10, the adjustment ring 72 will lift, which in turn extends the cylinder 30. Fluid is released from the cylinder 30 through the relief valve 150 to minimize the pressure rise, which adds an increased level of safety for the crusher 10 components when tramp material is inside of the bowl 24. The cylinder 30 is thus provides two distinct features by providing clamping force between the adjustment ring 72 and the frame 12 and, also, provides the necessary lift of the adjustment ring 72 with respect to the frame 12 when the crusher 10 needs to be cleared of material. This is an improvement over previous tramp systems that used nitrogen accumulators to regulate the pressure for the tramp releases. The operator may run the crusher 10 at the most efficient setting to maximize the tonnage of saleable product without concern of the crusher 10 stopping or jamming, since the crusher 10 may be cleared safely and automatically within a few minutes of a jam being detected.

Referring to FIG. 10, the adjustment ring assembly 72 is shown in further detail. The motor 80 is mounted on the upper section of the adjustment ring 72 and comprises a motor pinion 152 that interacts with an adjustment gear 154 (see also FIGS. 1 and 3). The adjustment gear 154 works together with the adjustment cap 38 and the bowl 24 to rotate the bowl 24 either clockwise or anti-clockwise for changing the crusher setting as required and to assemble or disassemble the bowl 24 from crusher 10.

Referring further to FIGS. 9 and 10, the locking cylinders 158 interact with the locking collar 160 to provide the means for securing or locking the bowl 24 in place during crushing operation. A passageway 162 allows the hose to be connected to the locking cylinders 158 to supply the fluid pressure needed to lock the bowl 24.

The foregoing is considered as illustrative only of the principles of the invention. Furthermore, since numerous modifications and changes will readily occur to those skilled in the art, it is not desired to limit the invention to the exact construction and operation shown and described. While the preferred embodiment has been described, the details may be changed without departing from the invention, which is defined by the claims.

1. A cone rock crusher for crushing rocks, said rock crusher comprising:
a frame;
a crusher head supported by said frame for gyration about an axis, said crusher head having fine tertiary crushing capability and coarse secondary crushing capability;
a removable domed feed plate supported by said crusher head;
a bowl supported by said frame spatially surrounding said crusher head;
a bowl liner;
a shaft supported by said frame, said shaft having an upper end and a lower end; and
means for varying said gyration of said crusher head.

2. The cone rock crusher according to claim 1 wherein said means for varying said gyration further comprises a sealed countershaft box assembly.

3. The cone rock crusher according to claim 2 wherein said sealed countershaft box assembly further comprises a removable cartridge.

4. The cone rock crusher according to claim 1 further comprising an eccentric bushing surrounding said shaft, said bushing providing an abutting surface along the length of said shaft from said upper end to said lower end, said bushing and said shaft being in linear contact along the length of said shaft when said shaft is gyrating.

5. The cone rock crusher according to claim 1 further comprising a mantle supported by said crusher head, said mantle having an angle of approximately 50° or greater from horizontal.

6. The cone rock crusher according to claim 1 wherein said bowl comprises coarse secondary crushing capability and fine tertiary crushing capability.

7. The rock crusher according to claim 1 wherein said frame further comprises a top half and a bottom half, said bottom half further comprising:
a mounting flange;
a shell;
at least one supporting arm; and
a central hub;
said bottom half of said frame being of one-piece, unitary construction.

8. The rock crusher according to claim 7 further comprising at least one arm guard for protecting said at least one supporting arm, said arm guards allowing said crushed rocks to form a dead bed on said arms to minimizing wear on said arms.

9. A cone rock crusher comprising:
a frame;
a head and shaft assembly comprising:
a crusher head for gyration about an axis, said crusher head supported by a socket formed by said frame;
a shaft supported by said head, said shaft having an upper end and a lower end; and
internal head and shaft assembly components;
a bowl supported by said frame, said bowl spatially surrounding said crusher head;
an eccentric bushing surrounding said shaft, said bushing providing an abutting surface along the length of said shaft from said upper end to said lower end, said bushing and said shaft being in linear contact along the length of said shaft when said shaft is gyrating;
an eccentric surrounding and retaining said bushing;
bearing means for supporting said eccentric;
means for lubricating said shaft and said bushing; and
means for varying said gyration of said crusher head.

10. The rock crusher assembly according to claim 9 wherein said lubrication means further comprises a vertical passage located within said shaft.

11. The rock crusher according to claim 10 further comprising a socket liner for said socket, said lubrication means further comprises a side entry port, said side entry port providing lubrication for said bearing means and said socket liner.

12. The rock crusher according to claim 9 further comprising at least one wiper located on said crusher head, said wiper providing a fluid barrier for said internal components of said head and shaft assembly.

13. The rock crusher according to claim 9 further comprising a counterweight, said counterweight providing balance for said rock crusher during said gyration of said crusher head.

14. The rock crusher according to claim 13 wherein said means for varying said gyration further comprises a sealed countershaft box assembly, said countershaft box assembly comprising a removable cartridge.

15. The rock crusher according to claim 14 wherein said countershaft box assembly further comprises:
a drive shaft; and
a plurality of roller bearings supporting said drive shaft, said roller bearings further providing means for preventing dirt from entering said countershaft box assembly.

16. The rock crusher according to claim 9 wherein said head and shaft assembly further comprises a mantle supported by said crusher head, said mantle having an angle of approximately 50° or greater from horizontal.

17. The rock crusher according to claim 16, further comprising a bowl liner supported by said bowl, said bowl liner having a profile length having a nip angle equal to or less than approximately 21° along the length of said profile.

18. A cone rock crusher comprising:
a frame;
a head and shaft assembly comprising:
a crusher head supported by said frame for gyration about an axis;
a shaft supported by said frame, said shaft having an upper end and a lower end; and
internal head and shaft assembly components;
a bowl supported by said frame spatially surrounding said crusher head;
an adjustment ring for alignment of said bowl;
an eccentric bushing surrounding said shaft;
a tramp release system for removing tramp material from said bowl, said tramp release system including at least one cylinder, said cylinder having an internal release valve for providing pressure release for said tramp release system; and
means for varying said gyration of said crusher head.

19. The cone rock crusher according to claim 18 further comprising a removable domed feed plate supported by said crusher head.

20. The cone rock crusher according to claim 15 wherein said means for varying said gyration further comprises a sealed countershaft box assembly, said countershaft box assembly further comprising a removable cartridge.

21. The cone rock crusher according to claim 20 further comprising a counterweight, said counterweight providing balance for said rock crusher during said gyration of said crusher head.

22. The rock crusher according to claim 18 wherein said at least one cylinder further comprises means for clamping said adjustment ring to said frame.

23. The rock crusher according to claim 22 wherein said at least one cylinder further comprises means for lifting said adjustment ring from said frame, when material is to be removed from said bowl.
